(19) United States
(12) Patent Application Publication
(10) Pub. No.: US 2023/0297059 A1
(43) Pub. Date: Sep. 21, 2023

(54) TECHNOLOGY FOR PROCESSING AND EXCHANGING SIGNALS BETWEEN A FIELD DEVICE AND A CONTROLLER

(71) Applicant: Phoenix Contact GmbH & Co. KG, Blomberg (DE)

(72) Inventors: Felix Schulte, Geseke (DE); Benjamin Klimmek, Aerzen (DE)

(21) Appl. No.: 18/010,505

(22) PCT Filed: Apr. 22, 2021
(86) PCT No.: PCT/EP2021/060499

§ 371 Date: Dec. 15, 2022

(30) Foreign Application Priority Data
Jun. 17, 2020 (LU) LU101865

(51) Int. Cl. G05B 19/05

(52) U.S. Cl. CPC G05B 19/054

(57) ABSTRACT

A signal processing module for processing electrical signals exchanged between at least one field device and a programmable logic controller (PLC) includes: a first connection component for electrically connecting the signal processing module to the at least one field device and the PLC; a communication component for sending information signals to the PLC; and a signal processing component for processing the electrical signals exchanged between the at least one field device and the PLC of a functional scope of the signal processing module. The information signals are indicative of the functional scope.

### CROSS-REFERENCE TO PRIOR APPLICATIONS

This application is a U.S. National Phase application under 35 U.S.C. § 371 of International Application No. PCT/EP2021/060499, filed on Apr. 22, 2021, and claims benefit to Luxembourg Patent Application No. LU 101865, filed on Jun. 17, 2020. The International Application was published in German on Dec. 23, 2021 as WO/2021/254677 under PCT Article 21(2).

### FIELD

The invention relates to processing and exchanging electrical signals between at least one field device and a programmable logic controller (PLC). In particular, a signal processing module for processing the electrical signals and a system for exchanging the electrical signals are provided.

### BACKGROUND

The process industry uses control and regulation technology to reduce the time and thus the costs of implementation when modernizing existing plants or to speed up the construction of new plants. In this context, plants for processing oil and gas are merely illustrative examples.

These use cases require signals to be exchanged and processed quickly and easily between at least one field device and a controller. For example, the field devices include sensors and actuators. The sensors transmit to the controller input signals that represent the status of process variables. The actuators receive output signals from the controller and perform actions for influencing the process variables.

Controllers with fixed input and output capabilities (I/O capabilities) can be connected directly to field devices. More flexibility and functionality can be achieved by means of signal processing modules (for example I/O cards), which process the signals in the signal path between the field device and the controller.

The document EP 3 149 550 A1 describes an I/O interposer system for processing an I/O signal transmitted between an I/O field device and a controller. The system comprises a base, an interposer circuit carrier (i.e. an I/O card) and an electrical connector. The electrical connector is attached to the base with a first connector half (i.e. a slot) and to the interposer circuit carrier with a second connector half. The first connector half and the second connector half are selectively engaged or engageable with each other in order to attach the interposer circuit carrier to the base.

Traditionally, however, the greater flexibility and functionality is associated with more maintenance and additional sources of error during an initial set-up or retrofitting. For example, it must be ensured that the correct I/O card is fitted in the correct slot. For example, if one of the I/O cards is defective, it must be identified in the control cabinet and replaced.

### SUMMARY

In an embodiment, the present invention provides a signal processing module for processing electrical signals exchanged between at least one field device and a programmable logic controller (PLC), comprising: a first connection component configured to electrically connect the signal processing module to the at least one field device and the PLC; a communication component configured to send information signals to the PLC; and a signal processing component configured to process the electrical signals exchanged between the at least one field device and the PLC according to a functional scope of the signal processing module, wherein the information signals are indicative of the functional scope.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic block diagram of a signal processing module for processing electrical signals from a field device for a PLC according to a first exemplary embodiment;

FIG. 2 shows a schematic block diagram of a signal processing module for processing electrical signals exchanged between a field device and PLC with energy storage according to a second exemplary embodiment;

FIG. 3 shows a schematic block diagram of a system for exchanging electrical signals between a field device and PLC according to a first exemplary embodiment; and

FIG. 4 shows a schematic block diagram of a system for exchanging electrical signals between field device and PLC according to a second exemplary embodiment.

### DETAILED DESCRIPTION

In an embodiment, the present invention provides a technique for processing and exchanging signals between at least one field device and a controller, which reduces or eliminates the set-up and maintenance effort traditionally associated with flexible functionality.

Exemplary embodiments of the invention, which can optionally be combined with one another, are disclosed below with partial reference to the accompanying drawings.

A first aspect relates to a signal processing module for processing electrical signals exchanged between at least one field device and a programmable logic controller (PLC). The signal processing module comprises a first connection component which is configured to electrically (or electroconductively) connect the signal processing module to the at least one field device and the PLC. Furthermore, the signal processing module comprises a communication component that is configured to send information signals to the PLC. Furthermore, the signal processing module comprises a signal processing component configured to process the electrical signals exchanged between the at least one field device and the PLC according to a functional scope of the signal processing module, wherein the information signals indicate (or specify) the functional scope.

In one exemplary embodiment, where the communication component sending the information signals to the PLC specifying the functional scope of the processing of the electrical signal exchanged between the at least one field device and the PLC, the PLC can determine whether a correct or sufficient (for example functionally correct or sufficient) signal processing module is present.

For example, when a process controlled by the PLC (implemented, for example, by the at least one field device) is changed or extended, it can be determined whether this process can be executed by means of the functions of the signal processing module according to the functional scope. Alternatively or additionally, the PLC can check step by step the process sequence control in order to ensure that a function required at each step is included in the indicated (or specified) functional scope.

In the same exemplary embodiment or in a further exemplary embodiment, the PLC (for example, in a system for exchanging the electrical signals between the at least one field device and the PLC) can be connected electroconductively to several second connection components and, based on the specified functional scope, check whether the signal processing module is connected electroconductively to the correct second connection component via its first connection component.

The (preferably processed) electrical signals from the signal processing component can be sent to the PLC by means of the communication component (preferably via the first connection component). Alternatively or additionally, the electrical signals (preferably to be processed) can be received by the PLC by means of the communication component (preferably via the first connection component) and routed to the signal processing component.

The communication component can provide a serial interface to the PLC (for example, on the control-side portion of the first connection component). The PLC can provide a corresponding serial interface to the signal processing module (for example, at the port of the PLC that is electrically connected to the second connection component). For example, both the electrical signals and the information signals can be exchanged via the serial interfaces connected to each other by means of the first and second connection components.

The communication component and/or the signal processing component can be adapted to send the information signals indicating the functional scope. The information signals indicating the functional scope can be sent (preferably to the PLC) in response to the electrical (or electroconductive) connection (for example, of the first connection component with a corresponding second connection component to the PLC) and/or in response to the electroconductive connection of the signal processing module to the PLC and/or in response to a request for the functional scope received (for example, wirelessly or via the first connection component) from the PLC. Herein, for example, the electroconductive connection can comprise bringing the first connection component into contact with a second connection component.

The electrical signals can have one or several values (for example, an actual value in the input signal or a set-point value in the output signal) and/or be used to transmit one or several values. The values can be related to process variables.

The at least one field device can be part of a (for example, production-engineering or process-engineering) system and/or be, for example, a technical device in the field of automation technology, which is used or can be used in an automation process.

The PLC can be referred to, in short, as controller. The PLC can be an automation controller.

The at least one field device can be located remotely from the PLC. For example, the at least one field device can be remotely controlled by the PLC by means of the electrical signals.

The processing of the electrical signals can include, for example, a conversion and/or evaluation of the electrical signals.

The at least one field device can comprise an actuator and/or a sensor. For example, the actuator can be a control element or a valve. For example, the field device can comprise a sensor, and/or the field device and/or the signal processing component can comprise a transmitter. The transmitter can be designed to convert an input variable received from the sensor into an output variable according to a fixed relationship. The functional scope can determine the transmitter. For example, the functional scope can indicate whether a transmitter is present and/or whether the transmitter is a transducer, a measuring amplifier and/or a measuring converter.

The PLC can be a controller for controlling and/or regulating the at least one field device, for example an automation process. For example, the PLC can thereby read information from the field devices and/or send control commands to the field devices. Furthermore, the PLC can process the information and/or control commands based on, for example, a user program. Alternatively or additionally, the PLC can be controlled and/or read out by another PLC and/or control station. The control station can include another PLC, which can be designed to control and/or read out the PLC. The readout can include a readout of the exchanged electrical signals and/or status messages of the signal-processing modules.

The first connection component can be an electrical connection component with a plurality of electrical contacts. Alternatively or additionally, the first connection component can be a connector half, e.g. a socket, a built-in plug or a contact strip.

The first connection component can be designed (for example, for the exchange of the electrical signals between the signal processing module and the PLC) to connect electrically and/or mechanically the signal processing module to a connection component (also: second connection component) corresponding to the first connection component. Alternatively or additionally, the second connection component can be a connector half, for example a socket, a built-in plug or a slot.

The communication component can be designed to send and/or receive the electrical signals and/or the information signals between the signal processing module and the PLC. Alternatively or additionally, the communication component can be designed to transmit the electrical signals and/or the information signals between the signal processing module and a control center, for example via the PLC. The electrical signals and/or the information signals can be transmitted from the signal processing module and the PLC to the control center.

The communication component can be designed to send the information signals indicating the functional scope in response to the electroconductive connection by means of the first connection component, and/or the electroconductive connection of the signal processing module to the PLC, and/or a request for the functional scope received from the PLC via the first connection component.

The information signals can also be sent via the first connection component together with the electrical signals, for example by means of a serial data transmission. Alternatively or additionally, the information signals can be transmitted to the PLC via a (for example separate) electrical conductor, an optical conductor and/or a radio signal.

The communication component can be designed to send the information signals to the PLC via the first connection component and/or a wireless interface. The communication component can comprise a wireless interface (for example a radio interface) and/or a wired interface, preferably to the first connection component and/or for communication with the PLC.

The first connection component can be arranged at an edge of the signal processing module and/or can be plugged or pluggable together for the electroconductive connection with a second connection component of a system comprising the PLC.

The signal processing module can (for example, according to the functional scope) be designed to process analogue and/or digital electrical signals, preferably logic level electrical signals and/or modulated electrical signals.

For example, the analogue electrical signals can have a stepless, continuous and/or smooth voltage waveform or current waveform, whereby the analogue signals have a continuous waveform.

The digital electrical signals can (for example with regard to voltage or current) have edges, one or more discrete levels and/or a step-shaped waveform. The logic signal can correspond to a specified signal form, for example transistor-transistor logic (TTL). Alternatively, the digital electrical signals can have discrete Fourier components. The modulated electronic signal can comprise a carrier frequency or one or more sub-carrier frequencies.

The functional scope of the signal processing module can correspond to a functional or internal structure of the signal processing module. The functional scope can, for example, be determined and/or designed in terms of programming and/or circuitry.

The signal processing component can comprise an electrical circuit (for example, discrete or integrated). The signal processing component can be designed to perform a function (for example, a signal conversion) according to the functional scope. Alternatively or additionally, the signal processing component can comprise a digital signal processor or a microcontroller in order to perform and/or to control the functional scope of the signal processing component.

Alternatively or additionally, the signal processing module (for example, the signal processing component) can comprise galvanic isolating circuit (also: isolating circuit or separation plane) of the electrical signals exchanged between the communication component and the signal processing component. Alternatively or additionally, an isolating circuit can be provided between a field-side portion of the first connection component (or a field connection of the signal processing module) and the signal processing component (or the communication component).

The signal processing module can process (for example, work through, convert and/or map) the electrical signals exchanged between the at least one field device and the PLC depending on or according to the respective functional scope.

The exchanged signals can include incoming and/or outgoing signals.

For example, an incoming signal can be transmitted from the at least one field device to the signal processing module (preferably via the field-side portion of the first connection component). The signal transmitted to the signal processing module can be processed by the signal processing component of the signal processing module according to the functional scope. Furthermore, the processed electrical signal can be transmitted from the signal processing module to the PLC (preferably via a control-side portion of the first connection component). In the course of the transmission (for example, as part of a serial data transmission), the signal processing module and/or the communication component can transmit the functional scope to the PLC by means of the information signals, for example, so that the PLC can make settings at a port of the PLC that is electrically connected to the second connection component and/or control processes in the automation process that are dependent on the signal processing module (for example, in the event of a failure or error of the signal processing module), depending on the functional scope. Alternatively or additionally, the signal processing module can send the information signals to the PLC when the signal processing module is connected to the PLC.

For example, an outgoing signal can be transmitted from the PLC to the signal processing module (preferably via the control-side portion of the first connection component). After the transmission, the signal processing module processes the signal according to the functional scope by means of the signal processing component of the signal processing module. The processed signal is further transmitted from the signal processing module to the at least one field device (preferably via the field-side portion of the first connection component).

Furthermore, the signal processing module can have an energy supply component (or in short: energy component). The energy supply component can be designed to supply the signal processing module with electrical energy. Thereby, the electrical energy of the energy supply component can be provided, for example, by an external energy source (i.e. outside of the signal processing module, for example an energy component of the system) and/or by an internal energy source (i.e. an energy source of the signal processing module). For example, the external energy source can transmit the energy to the energy supply component via the first connection component. The internal energy source can be, for example, a storage for electrical energy that can optionally be charged from an external energy source, preferably for uninterrupted power supply.

The signal processing module can comprise, according to the functional scope, a digital input (DI), a digital output (DO), an analogue input (AI) and/or an analogue output (AO), preferably at the field-side portion of the first connection component (or the field connection). The DI can be an input for detecting and/or processing digital electrical signals. The DO can be an output for processing and/or outputting digital electrical signals. The AI can be an input for detecting and/or processing analogue electrical signals. The AO can be an output for processing and/or outputting analogue electrical signals.

The functional scope of the signal processing module can include at least one of the following signal processing. A first signal processing comprises a conversion of an electrical signal detected by the at least one field device to a DI of the PLC electrically connected through the first connection component. A second signal processing comprises a conversion of an electrical signal detected by the first connection component from a digital DO of the PLC to the at least one field device. A third signal processing comprises a conversion of an electrical signal detected by the at least one field device to an AI of the PLC electrically connected through the first connection component. A fourth signal processing comprises a conversion of an electrical signal detected by the first connection component from an AO of the PLC to the at least one field device. A fifth signal processing comprises a provision of a digital DI to the at least one field device designed to detect the electrical signals from the at least one field device. A sixth signal processing comprises a provision of a DO to the at least one field device designed to output the electrical signals to the at least one field device. A seventh signal processing comprises the provision of an AI to the at least one field device designed to detect the electrical signals from the at least one field device. An eighth signal processing comprises the provision of an AO to the at least one field device designed to output the electrical signals to the at least one field device.

The functional scope can include at least two alternative signal processing states of the signal processing module. Alternatively or additionally, the communication component and/or the processing component can be designed to receive control signals from the PLC via the first connection component. The control signals can specify a state of the alternative states. The signal processing component can further be adapted to accept the predetermined signal processing state.

The two alternative states can, for example, be the provision of a DI and of a DO or the provision of an AI and of an AO. For example, the PLC can switch between the two alternative states by means of the control signals.

Alternatively or additionally, the control signals can be designed to control the signal processing module. The control signals can control a function of the signal processing module depending on the functional scope. The control signals can, for example, activate or deactivate a function depending on the functional scope.

Alternatively, the functional scope of the signal processing module can be unchangeable. The PLC can be designed to detect the functional scope by means of the information signals and output an error message (for example to the control center) if the functional scope is not suitable for a sequence control stored in the PLC.

The information signals, for example the indication of the functional scope, can include at least one of the following identifiers. A signal processing module identifier can indicate or (for example, uniquely) identify the signal processing module. A connection component identifier can indicate the first connection component of the signal processing module. A connection state identifier can indicate a state of the electroconductive connection between the signal processing module and the PLC. A functional scope identifier can indicate the functional scope. An operational state identifier can indicate an operational state of processing the electrical signals and/or an operational state of the signal processing module. An application identifier can indicate an application (for example, compatible with the signal processing module) of the electrical signals and/or a device type (for example, compatible with the signal processing module) of the at least one field device. A waveform identifier can indicate a waveform of the electrical signals (for example, between the signal processing module and the at least one field device).

The signal processing module identifier can uniquely indicate or determine the signal processing module. For example, each signal processing module can have a serial number, an address or an identifier of its serial interface.

The connection component identifier can, for example, comprise an identifier, a technical structure and/or a function of the first connection component.

The functional scope identifier can include, for example, an identifier describing the functional scope and/or an identifier for the selected functional scope.

The operational state identifier can, for example, indicate an identifier to a function of one of the components of the signal processing module and/or include an identifier to an error (for example, an error code) of the signal processing module.

The first connection component and/or the communication component and/or the signal processing component can be designed (for example, according to the functional scope) for unidirectional or bidirectional communication of the electrical signals, preferably with the PLC and/or the at least one field device.

The first connection component and/or the communication component and/or the signal processing component can be designed for serial communication of the electrical signals and/or the information signals with the PLC. For example, both the electrical signals and the information signals can be exchanged with the PLC by using the same communication component and/or the same serial interfaces.

Optionally, the communication component can comprise a wireless (for example separate or redundant) interface for communicating the information signals.

The communication component and/or the signal processing component can be designed to periodically or continuously detect (for example, receive) and/or periodically or continuously process and/or periodically or continuously send the electrical signals. For example, the signal processing module can be designed to periodically or continuously detect the electrical signals at the field-side portion of the first connection component.

The periodic or continuous detecting can allow to monitor the at least one field device. The periodic or continuous detecting can be referred to in technical terms as monitoring. For example, a time course of the electrical signals or one of the electrical signals can be detected.

A second aspect relates to a system for exchanging electrical signals between at least one field device and a programmable logic controller (PLC). The system includes the PLC, which provides at least one port for exchanging the electrical signals. Further, the system comprises at least two second connection components which are connected electroconductively to the at least one port of the PLC and which are each designed to connect electroconductively the PLC to a signal processing module according to the first aspect via its first connection component. The PLC is designed to receive information signals from the signal processing modules and to exchange the electrical signals with the respective signal processing module via the at least two second connection components according to a functional scope of the respective signal processing module, wherein the information signals from the respective signal processing module indicate the functional scope of the respective signal processing module.

Each second connection component can comprise a slot. The electroconductive connection can comprise plugging of the first connection component (for example a contact strip) into the second connection component.

The system can further comprise at least two of the signal processing modules, whose first interconnection components are each electroconductively connected to a different one of the second interconnection components. The signal processing modules can each be designed to send the information signal to the PLC and process the electrical signals exchanged between the at least one field device and the PLC according to the functional scope of the respective signal processing module.

The PLC can further be designed to send control signals via the second connection component in order to control the respective signal processing module. For example, the functional scope can comprise at least two alternative states of processing the electrical signals (i.e. at least two alternative signal processing states of the signal processing module). The control signals can specify a state of the alternative states.

The information signals can comprise or indicate an identifier of the respective signal processing module. Alternatively or additionally, each port can be a serial port.

The information signals can indicate an identifier of the respective signal processing module. The at least one port provided by the PLC can comprise a serial port electroconductively connected to the at least two second connection components for exchanging the electrical signals. The PLC can further be designed to exchange the electrical signals with the at least two signal processing modules (100) via the serial port, wherein the at least two signal processing modules are differentiated and/or addressed by their respective identifiers.

For example, the electrical signals can be exchanged between the PLC and the at least two signal processing modules via the same serial port. The exchange of electrical signals can comprise time frames (technically also: frames), which are subdivided, for example, temporarily into time frames. The time frames can each include the identifier of the respective signal processing module, for example as sender in a transmission from the signal processing module to the PLC or as receiver in a transmission from the PLC to the signal processing module.

Alternatively or additionally, the PLC can provide at least two ports for transmitting the electrical signals. Each of the ports can be uniquely electroconductively connected to one of the at least two second connection components. Optionally, each of the at least two ports can be a serial port.

A respective PLC port can be electroconductively connected to another respective one of the at least two second connection components. The PLC can further be designed to configure, in response to the information signals from the at least two signal processing modules, the port electroconductively connected to the respective second connection component according to the functional scope indicated via that port.

The PLC can further include a connection to a higher-level control center. The PLC can be designed to send the electrical signals, the information signals and/or signals derived from them to the higher-level control center. Alternatively or additionally, the PLC can be designed to receive instructions from the higher-level control center to control the processing of the electrical signals and to send control signals to one of the signal processing modules in accordance with the instructions. Alternatively or additionally, the PLC can be designed to receive instructions from the higher-level control center to control the at least one field device and to send electrical signals to the at least one field device in accordance with the instruction.

The PLC can further be designed to detect a discrepancy between a functional scope or an identifier associated with one of the second connection components and a functional scope or identifier, respectively, received via that one second connection component in the information signals. Further, the PLC can also be designed to output an error message, for example to the higher-level control center, in response to the detected deviation.

The at least one port of the PLC can be connected electroconductively to an interface of a microprocessor of the PLC. The microprocessor can, for example, be configured to execute a program code or a computer program, respectively. Furthermore, the microprocessor may comprise at least one computing unit.

Alternatively or additionally, the at least one port of the PLC may be connected electroconductively to the control-side portion of the second connection component via a back wiring (for example at a marshalling or patch plane of the system). Optionally, the back wiring can comprise an electrical connection between the ports of the PLC and the second connection components that is made invariable by control signals from the PLC.

Furthermore, the second aspect may further comprise any feature disclosed in the context of the signal processing module according to the first aspect, or a feature corresponding to the system.

In any aspect, the electrical signals detected by the at least one field device (for example, at the signal processing module) can also be referred to as input signals (I-signals). Alternatively or additionally, the electrical signals output to the at least one field device (for example from the signal processing module) are also referred to as output signals (O-signals). Alternatively or additionally, the field-side electrical signals (for example, the signals exchanged between the signal processing module and the at least one field device) are referred to as I/O signals.

The PLC can be implemented by means of a controller (for example with a microcontroller and/or a microprocessor). One exemplary embodiment of the system, for example its PLC, can communicate with another (for example remote) exemplary embodiment of the system or an input/output (I/O) rack. For example, the respective PLCs of two or more exemplary embodiments of the system can communicate via a digital bus or a network.

The port can be an input and/or output of the PLC, which is designed to receive or send the exchanged electrical signals.

The system can process the electrical signals by means of the signal processing module and thus pass them on between the field device and a higher-level control center. For this purpose, the signal processing module can forward and process the electrical signal between the field device and the PLC port. In doing so, the signal processing module can process the electrical signal depending on the functional scope and thus make it available to the port and/or the field device.

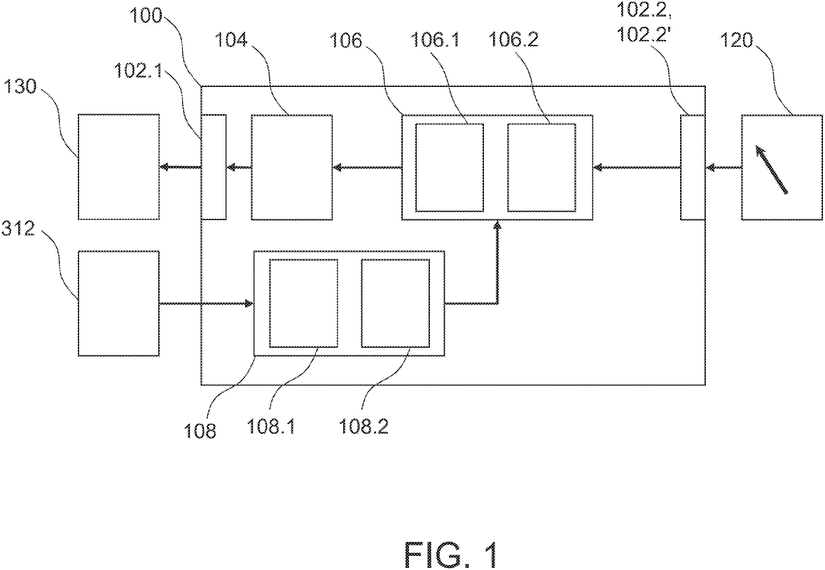

FIG. 1 shows a first exemplary embodiment of a signal processing module generally designated by reference numeral 100 (in short: module) for processing electrical signals exchanged between a field device 120 and a programmable logic controller (PLC) 130.

For this purpose, the signal processing module 100 has a first connection component 102 for electroconductively connecting the signal processing module 100 to the PLC 130. Furthermore, the module 100 comprises a communication component 104 configured to send information signals to the PLC 130 via the first connection component 102. A signal processing component 106 of the module 100 is configured to process the at least one electrical signal according to a functional scope of the signal processing module 100. In order to send the processed electrical signal to the PLC or to receive from the PLC the electrical signal to be processed, the signal processing component 106 is connected electroconductively to the communication component 104.

Preferably, the signal processing component 106 comprises a separation plane 106.1 and a controller 106.2, wherein the separation plane 106.1 provides a galvanic isolation, for example by means of an optocoupler, in the signal path between field device 120 and PLC 130 (for example, between the communication component 104 and the signal processing in the signal processing component 106). A controller 106.2 (for example, a signal processor) of the signal processing component 106 is designed to process the electrical signal according to the functional scope.

Furthermore, the signal processing module 100 comprises a connection 102.2 and/or 102.2′ (for example, an input or an output) to the field device 120. The connection 102.2 and/or 102.2′ connects electroconductively the signal processing component 106 to the field device 120. The connection 102.2 and/or 102.2′ can depend on the functional scope and/or be adapted to the field device 120, for example with regard to a signal shape and/or a connector half.

The connector can be a field-side portion 102.2 of the first connection component 102 (for example, part of a common connector half of the module 100) together with a control-side portion 102.1 of the first connection component 102. Alternatively or additionally, the signal processing module 100 can comprise a separate field connection 102.2′. The field device 120 can be connected directly to the module 100 via the separate field connection 102.2′.

The functional scope of the first exemplary embodiment of the module 100 shown schematically in FIG. 1 comprises a signal input (in short: input). For example, the signal processing component control can comprise an input circuit that detects the input signal from the field device according to the functional scope, such as an analogue-to-digital converter for analogue input (AI) to the field device 120.

In a variant of the first exemplary embodiment, the signal path between field device 120 and PLC 130 can include the connection 102.2 and/or 102.2′ as a signal output (in short: output) to the field device 120, i.e. the functional scope includes an output, for example an analogue output (AO).

For bidirectional communication (i.e. for bidirectional exchange of the signals), the first exemplary embodiment and the variant can be combined.

In any variation, the part of the signal path between the communication component 104 and the PLC 130 has serial data transmission.

Moreover, the communication component 104 and/or the signal processing component 106 is designed to send the information signals when electroconductively connecting the first connection component 102 to the PLC 130. Thereby, preferably, the signal processing component 106 controls the communication component 104 to transmit the information signals.

Furthermore, for supplying at least the signal processing component 106, the signal processing module 100 has an energy component 108 comprising a controller 108.1 and a separation plane 108.2. The controller 108.1 is configured to provide electrical supply energy to at least the signal processing component 106 for its operation. The separation plane 108.2 can provide a galvanic isolation, for example by means of a transformer, in the power path between an external energy source (or the controller 108.1) and at least the signal processing component 106. In this case, the energy component 108 is supplied with energy from an energy component 312 that is external to the signal processing module 100. The energy component 312 can be implemented in the aforementioned system. The energy component 312 can be a switching power supply.

The direction of exchange of the electrical signals and the processing (for example, conversion of the electrical signals) transmitted from the field device 120 to the PLC 130 shown in FIG. 1 is exemplary. For example, a unidirectional communication can exist between the communication component 104 and the PLC 130. Alternatively or additionally (for example for the functional scope of an output), the reverse direction of the exchange of the electrical signals or a bidirectional communication can be implemented.

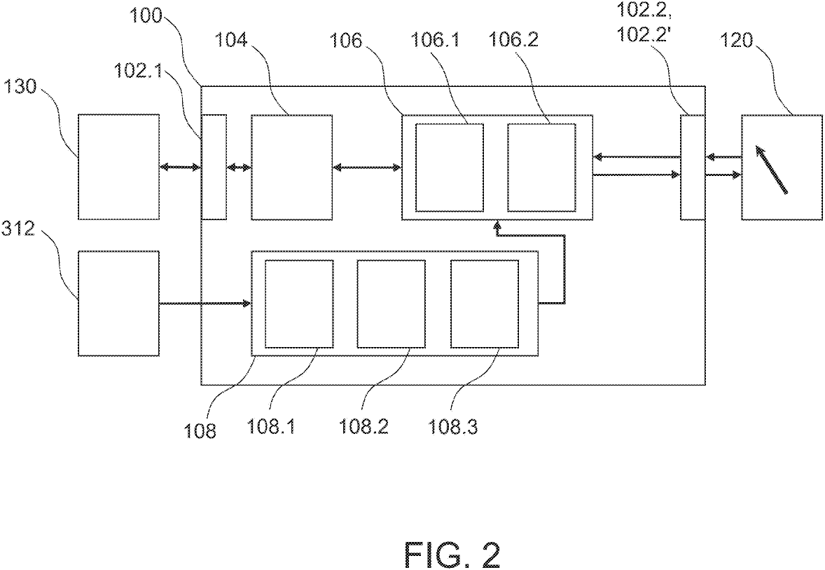

FIG. 2 shows schematically a second exemplary embodiment of the module 100. The second exemplary embodiment can be a further development of the first exemplary embodiment shown schematically in FIG. 1.

The energy component 108 can further comprise an energy storage 108.3. In this case, the energy storage 108.3 is thereby designed to supply at least the signal processing component 106 with the supply energy.

Alternatively or additionally, electrical signals can be processed and transmitted from the PLC 130 to the field device 120 and/or vice versa. A bidirectional connection can exist between the communication component 104 and the PLC 130. Thereby, the bidirectional connection can use serial communication, for example an industrial transmission protocol.

In any exemplary embodiment, the signal processing module 100 can be configured to receive control signals from the PLC 130 via the first connection component 102.

Alternatively or additionally, the signal processing module 100 can be designed as an interface for transmitting the electrical signals between the at least one field device 120 and the controllers (i.e. the PLC 130). In doing so, the signal processing module 100 can process (for example, convert into each other) standard signals from the PLC 130 and/or the field device 120 (for example, a sensor).

Alternatively or additionally, the bidirectional connection can fulfil the requirements of an application with safety integrity level or SIL. Furthermore, the communication component 104 can comprise various mechanisms for securing the connection or the communication, respectively.

The functional scope can include at least one of the following functions or applications: analogue input (AI), analogue output (AO), digital input (DI), digital output (DO), temperature measurements, vibration measurement methods, SAFETY relays, relays or feed-through.

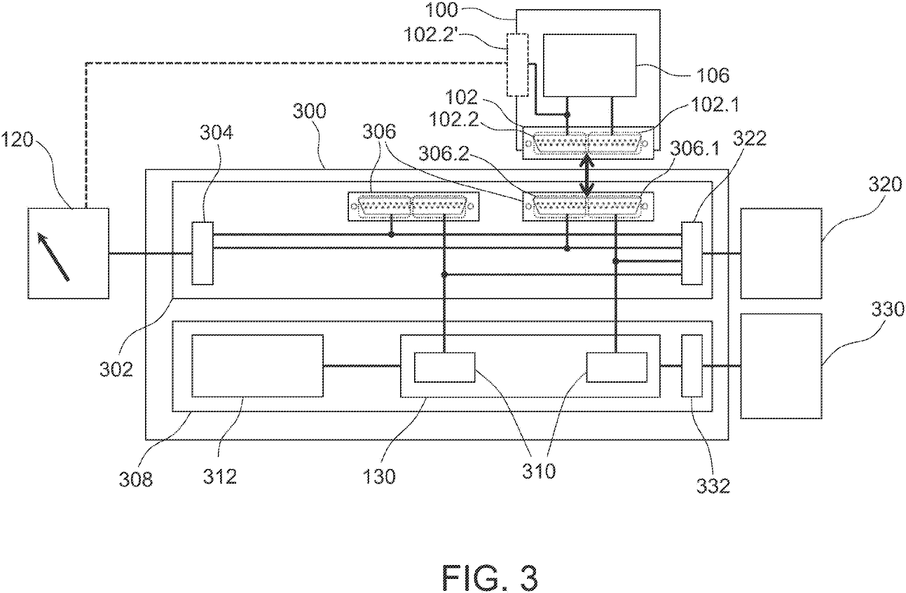

FIG. 3 shows a first exemplary embodiment of a system, generally designated by reference numeral 300, for exchanging the electrical signals between the field devices 120 and the PLC 130, and optionally for forwarding the electrical signals to a higher-level control center 330. The system 300 thereby comprises the PLC 130, which provides at least one port 310 for exchanging the signals. The system 300 further comprises a second connection component 306, which is in each case connected electroconductively to the port 310 and which is designed to connect electroconductively a signal processing module 100 via a first connection component of the signal processing module 100.

The signal processing module 100 is thereby designed to process the electrical signals exchanged between the field devices 120 and the PLC 130 according to a functional scope of the respective signal processing module 100.

The signal processing module 100 is further designed to transmit an information signal to the PLC 130 via the first connection component 102 and the second connection component 306. The PLC 130 is designed to configure, in response to the information signal, the port 310 which is electroconductively connected to the respective second connection component 306 according to the functional scope. Optionally, the PLC 130 is designed to control the signal processing module 100 by means of control signals.

The system 300 comprises a field connection 304 designed to connect electroconductively the at least one field device 120 to the respective signal processing module 100, preferably via the respective second connection component 306. Alternatively or additionally, a module-side field connection 103 for the respective field device 120 can be provided on the respective signal processing module 100.

Preferably, the field connection 304 (for example, the input or output to the field device 120) and the second connection component 306 are located in a marshalling or patch plane 302 of the system 300. The field-side portion 102.2 of the first connection component 102 or, respectively, the field-side portion 306.2 of the second connection component 306 can be connected electroconductively to the field connection 304 of the system 300 to the field device 120 via the marshalling or patch plane 302 (preferably a back wiring).

Furthermore, the system 300 comprises a control plane 308 comprising the PLC 130 and optionally an energy component 312. The energy component is thereby designed to provide a supply energy at least to the PLC 130 and/or the signal processing module 100.

Furthermore, the system 300 has a communication link between the PLC 130 and an external PLC 320 which can have control access to the PLC 130 and/or which is controlled by the PLC 130 and/or which is provided redundantly (for example, in the event of a failure of the PLC 130).

Alternatively or additionally, the signal processing module 100 can transmit a unique identifier to the PLC 130, preferably in the information signals. This identifier can allow the PLC 130 to detect whether a signal processing module 100 and/or which signal processing module 100 has been plugged into the respective second connection component 306 and/or which functional scope the respective signal processing module 100 has.

The PLC 130 can be designed to output the functional scope indicated in the information signals as information, for example on a local screen at the PLC 130 or via a web page generated by the PLC 130 that can be accessed via a network connection.

The PLC 130 can communicate the specified functional scope to the control center 330, so that the control center 330 can take it into account and/or output it when controlling a process using the PLC 130. Further, the signal processing module 100 can be considered in determining a control program of the PLC 130 depending on its functional scope. The determination of the control program can be automated and/or carried out manually by means of the control center 330. In particular, an optimization of the system 300 and/or of the process executed by the system 300 can be enabled thereby.

Alternatively or additionally, the identifier can be transmitted by means of a serial electrical signal. The transmission can further take place via a wired communication interface and/or a wireless communication interface. The identifier can further be configured to transmit to the PLC 130 at least the functional scope and/or an identifying feature of the signal processing module 100, with the transmission taking place when the first connection component is connected to the second connection component.

Alternatively or additionally, the identifier can comprise an identifying feature of the port 310, the first connection component 102, the second connection component 306, an identifying feature of the functional scope (for example, for functioning as Al, AO, DI, or DO), an identifying feature of the configuration of the signal processing module 100 (for example, for subsequently adjusting the configuration), and/or an identifying feature of a malfunction or functional limitation of the signal processing module 100.

In particular, the identifier can simplify an operation and/or a commissioning, as the system 300 or the PLC 130, respectively, provides information of the signal processing module 100. The signal processing module 100 can further communicate a functional status related to the processing of the electrical signal, for example a so-called “online” status.

Alternatively or additionally, the system 300 or the PLC 130 can configure an energy management of the energy component 312 based on the identifier. Thereby, the identifier can include an identifying feature for the energy absorption. Furthermore, an energy curve over a certain period of time can be determined. The identifier can further be used to advantageously plan the maintenance of the signal processing module 100, the system 300 and/or the PLC 130.

Alternatively or additionally, the functional scope of a system 300 for forwarding electrical signals between field devices 120 and a higher-level control center 330 can be advantageously adapted and specifically developed. In this regard, a configuration and/or a calibration of the signal processing module 100 can be performed and/or adjusted by the control station 330 and/or PLC 130. Further, an operational status of the signal processing module 100 can be detected by the control station 330 and/or the PLC 130.

The operational status can include the hours of operation of the signal processing module 100, a fault monitoring of the signal processing module 100, a monitoring of the electrical signals, a monitoring of the maintenance intervals of the signal processing module 100, and/or a predictive maintenance of the signal processing module 100.

Alternatively or additionally, a control and/or configuration of the field devices 120 (for example, by processing the electrical signals in the signal processing module 100 and/or by the PLC 130) can be performed by using signals from an industrial fieldbus (for example, signals from a “Highway Addressable Remote Transducer” or HART).

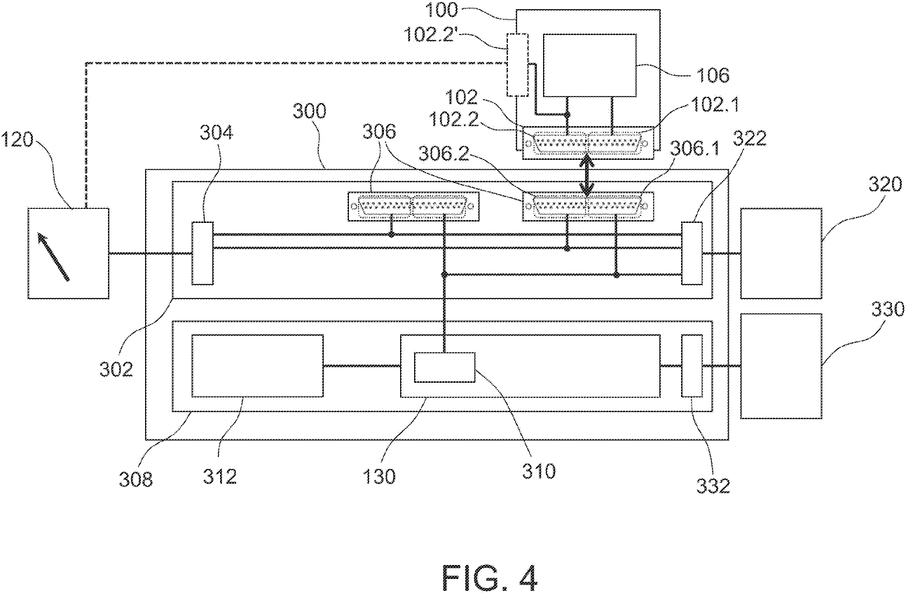

While FIG. 3 shows a first exemplary embodiment of the system 300, where the back wiring of the marshalling or patch plane 302 comprises a unique mapping between ports 310 and the second connection components 306, FIG. 4 shows a second exemplary embodiment of the system 300, where the identifier determines which of the signal processing modules 100 is addressed when exchanged over a common serial bus.

As it can be seen from the above exemplary embodiments, exemplary embodiments can provide a signal processing module that can meet different customer requirements in the field of process automation. The configuration costs and/or the maintenance costs of a system in the field of process automation can be capable of being reduced.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of Reference Numerals
Signal processing module 100
First connection component, preferably contact strip 102
Control-side portion of the first connection component 102.1
Field-side portion of the first connection component 102.2
Field connection of the signal processing module 102.2′
Communication component 104
Signal processing component 106
Separation plane of the signal processing component 106.1
Control of the signal processing component 106.2
Energy component 108
Control of the energy component 108.1
Separation plane of the energy component 108.2
Energy component energy storage 108.3
Field device 120
Programmable logic controller (PLC) 130
System 300
Marshalling or patch plane 302
Field connection of the system 304
Second connection component, preferably slot 306
Control-side portion of the second connection component 306.1
Field-side portion of the second connection component 306.2
Control plane 308
Ports 310
Energy component of the system 312
External PLC, preferably redundant PLC 320
Connection to external PLC 322
Control center (also: control station) 330
Connection to the control center, preferably network connection 332

1. A signal processing module for processing electrical signals exchanged between at least one field device and a programmable logic controller (PLC), comprising:
a first connection component configured to electrically connect the signal processing module to the at least one field device and the PLC;
a communication component configured to send information signals to the PLC; and
a signal processing component configured to process the electrical signals exchanged between the at least one field device and the PLC of a functional scope of the signal processing module,
wherein the information signals are indicative of the functional scope.

2. The signal processing module of claim 1, wherein the communication component is configured to send the information signals indicative of the functional scope in response to;
the electric connection by the first connection component, and/or
the electric connection of the signal processing module to the PLC, and/or
a request for the functional scope received from the PLC via the first connection component.

3. The signal processing module of claim 1, wherein the communication component is configured to send the information signals to the PLC via the first connection component and/or a wireless interface.

4. The signal processing module of claim 1, wherein the first connection component is arranged at an edge of the signal processing module and for electrical connection is mated or configured to mate with a second connection component of a system comprising the PLC.

5. The signal processing module of claim 1, wherein the signal processing module is configured to process analogue and/or digital electrical signals of the functional scope.

6. The signal processing module of claim 1, wherein the functional scope of the signal processing module comprises at least one of the following signal processing operations:
converting an electrical signal detected by the at least one field device to a digital input (DI) of the PLC electrically connected by the first connection component;
converting an electrical signal detected by the first connection component
from a digital output (DO) of the PLC to the at least one field device;
converting an electrical signal detected by the at least one field device to an analogue input (AI) of the PLC electrically connected by the first connection component;
converting an electrical signal detected by the first connection component from an analogue output (AO) of the PLC to the at least one field device;
providing a digital input (DI) towards the at least one field device, the DI being configured to acquire the electrical signals of the at least one field device;
providing a digital output (DO) towards the at least one field device, the DO being configured to output the electrical signals to the at least one field device;
providing an analogue input (AI) towards the at least one field device, the AI being configured to acquire the electrical signals of the at least one field device; and
providing an analogue output (AO) to the at least one field device, the AO being configured to output the electrical signals to the at least one field device.

7. The signal processing module of claim 1, wherein the functional scope comprises at least two alternative states of signal processing by the signal processing module.

8. The signal processing module of claim 1, wherein the functional scope of the signal processing module is unchangeable.

9. The signal processing module of claim 1, wherein the information signals comprise at least one of the following identifiers:
a signal processing module identifier indicative of the signal processing module;
a connection component identifier indicative of the first connection component of the signal processing module;
a connection state identifier indicative of a state of the electrical connection between the signal processing module and the PLC;
a functional scope identifier indicative of the functional scope;
an operational state identifier indicative of an operational state of processing the electrical signals and/or an operational state of the signal processing module;
an application identifier indicative of an application of the electrical signals and/or indicative of a device type of the at least one field device; and
a waveform identifier indicative of a waveform of the electrical signals.

10. The signal processing module of claim 1, wherein, of the functional scope, the first connection component and/or the communication component and/or the signal processing component is configured for unidirectional or bidirectional communication of the electrical signals.

11. The signal processing module of claim 1, wherein the first connection component and/or the communication component and/or the signal processing component is configured for serial communication of the electrical signals and/or the information signals with the PLC.

12. A system for exchanging electrical signals between at least one field device and a programmable logic controller (PLC), comprising:
the PLC providing at least one port for exchanging the electrical signals; and
at least two second connection components which are electrically connected to the at least one port of the PLC and which are each configured to electrically connect the PLC to the signal processing module of claim 1 via its first connection component,
wherein the PLC is configured to receive information signals from the signal processing module and to exchange the electrical signals with the respective signal processing module via the at least two second connection components of a functional scope of the respective signal processing module, and
wherein the information signals from the respective signal processing module are indicative of the functional scope of the respective signal processing module.

13. The system of claim 12, further comprising:
at least two of the signal processing modules, each of whose first connection components are electrically connected to a different one of the second connection components and each of which is configured to send the information signal to the PLC and to process the electrical signals exchanged between the at least one field device and the PLC of the functional scope of the respective signal processing module.

14. The system of claim 12, wherein the information signals are indicative of an identifier of the respective signal processing module, and the at least one port provided by the PLC comprises a serial port electrically connected to the at least two second connection components for exchanging the electrical signals,
wherein the PLC is configured to exchange the electrical signals with the at least two signal processing module via the serial port, and
wherein the at least two signal processing modules are differentiated and/or addressed by their respective identifiers.

15. The system of claim 12, wherein a respective port of the PLC is electrically connected to a respective other one of the at least two second connection components, and
wherein the PLC is configured to configure the port electrically connected to the respective second connection component in response to the information signals from the at least two signal processing modules of the functional scope indicated via that port.

16. The system of claim 12, wherein the PLC comprises a connection to a higher-level control center and is configured to:
send the electrical signals, the information signals, and/or the signals derived therefrom to the higher-level control center, and/or
receive instructions from the higher-level control center for controlling the processing of the electrical signals and send control signals in accordance with the instructions to one of the signal processing modules, and/or
receive instructions from the higher-level control center for controlling the at least one field device and send electrical signals to the at least one field device in accordance with the instruction.

17. The signal processing module of claim 5, wherein the analogue and/or digital electrical signals of the functional scope comprise logic level electrical signals and/or modulated electrical signals.

18. The signal processing module of claim 7, wherein the communication component is configured to receive control signals from the PLC via the first connection component, with the control signals specifying a state of the alternative states, and the signal processing component is configured to assume the specified signal processing state.

19. The signal processing module of claim 9, wherein the information signals comprise the indication of the functional scope.

20. The signal processing module of claim 10, wherein, of the functional scope, the first connection component and/or the communication component and/or the signal processing component is configured for unidirectional or bidirectional communication of the electrical signals with the PLC and/or the at least one field device.
